(19) United States
(12) Patent Application Publication
(10) Pub. No.: US 2003/0106042 A1
(43) Pub. Date: Jun. 5, 2003

(54) System and method for animating state diagram through debug connection

(76) Inventors: Steve Lynch, San Jose, CA (US); Hari Chandana Nidumolu, Sunnyvale, CA (US)

Correspondence Address: FAY KAPLUN & MARCIN, LLP, 15O BROADWAY, SUITE 702, NEW YORK, NY, 10038, US

(21) Appl. No.: 10/007,441

(22) Filed: Dec. 5, 2001

(51) Int. Cl. G06F 9/44; G09G 5/00

(52) U.S. Cl. 717/109; 717/113; 717/125; 345/762

(57) ABSTRACT

A method and system are described for animating state diagram through debug connection. In particular, a tool communication link is established between a graphical code generator and a target server. The target server is connected to a target system via a target communication link. A virtual communication channel is established within the target communication link between the target server and the target system. Animation data is received from the target system, via the target server, using the virtual communication channel and provided to the graphical code generator.

### BACKGROUND INFORMATION

The world of electronics is rapidly transitioning into digital devices filled with embedded technology such as 32-bit microprocessors, embedded software, and connectivity. Accordingly, embedded application development is increasing in many different industries including automotive, aerospace, consumer electronics, telecommunications, data communications, office automation, etc. With the increasing complexity of embedded systems and software, code developers are faced with the challenge of developing considerable amounts of textual code. Graphical code generators offer embedded system developers significant benefits by enabling them to use graphical programming.

Graphical code generators allow developers to reduce the amount of code that must be manually written. In addition, the graphical code generators ease the edit-test-debug cycle by introducing debugging techniques. One of the most efficient debugging techniques for graphical code generators involves the animation of the graphical user interface (“GUI”) including, for example, the highlighting of the graphical constructs.

### SUMMARY OF THE INVENTION

In a preferred embodiment according to the present invention, a method and system is described for animating state diagrams through a debug connection. In particular, a tool communication link is established between a graphical code generator and a target server. The target server is connected to a target system via a target communication link. A virtual communication channel is established within the target communication link between the target server and the target system. Animation data is received from the target system, via the target server, using the virtual communication channel and provided to the graphical code generator.

### BRIEF DESCRIPTION OF DRAWINGS

FIG. 1A shows an exemplary embodiment of a networking system according to the present invention.

FIG. 1B shows an exemplary embodiment of a system according to the present invention without a network connection.

FIG. 2 shows an exemplary embodiment of a development environment for interactions between a host and target environment elements.

FIG. 3 shows an exemplary process implemented by a graphical code generator to develop an application software.

FIG. 4 shows an exemplary embodiment of a state transition diagram.

FIG. 5A shows an exemplary statechart.

FIG. 5B shows an exemplary statechart with state animations.

FIG. 6A shows a conventional development environment.

FIG. 6B shows an exemplary embodiment of a development environment according to the present invention.

FIG. 7 shows an exemplary embodiment of the internal architecture of a target server.

FIG. 8 shows an exemplary embodiment of a network link containing virtual channels according to the present invention.

FIG. 9A shows an exemplary method for communication between the graphical code generator and the target server according to the present invention.

FIG. 9B shows an exemplary method for communication of animation data between the application and the target server according to the present invention.

### DETAILED DESCRIPTION

The present invention may be further understood with reference to the following description of preferred exemplary embodiments and the related appended drawings, wherein like elements are provided with the same reference numerals.

A conventional embedded system may consist of a single-board microcomputer with software in a non-volatile memory such as read-only memory (“ROM”), flash memory, etc. An embedded system may include an operating system or the embedded system may be simple enough to be written as a single program. In order for the developer to create the program for the embedded system, the developer generates code. Graphical programming tools assist developers in this process. Particularly, graphical programming tools have eased the structural coding process by integrating animation into the development process, specifically the debugging process.

The present invention is preferably implemented as part of computer-aided software engineering graphical programming tools that employ animation (herein referred to as a “graphical code generator”), such as, for example, BetterState™ by Wind River Systems, Inc. of Alameda, Calif.

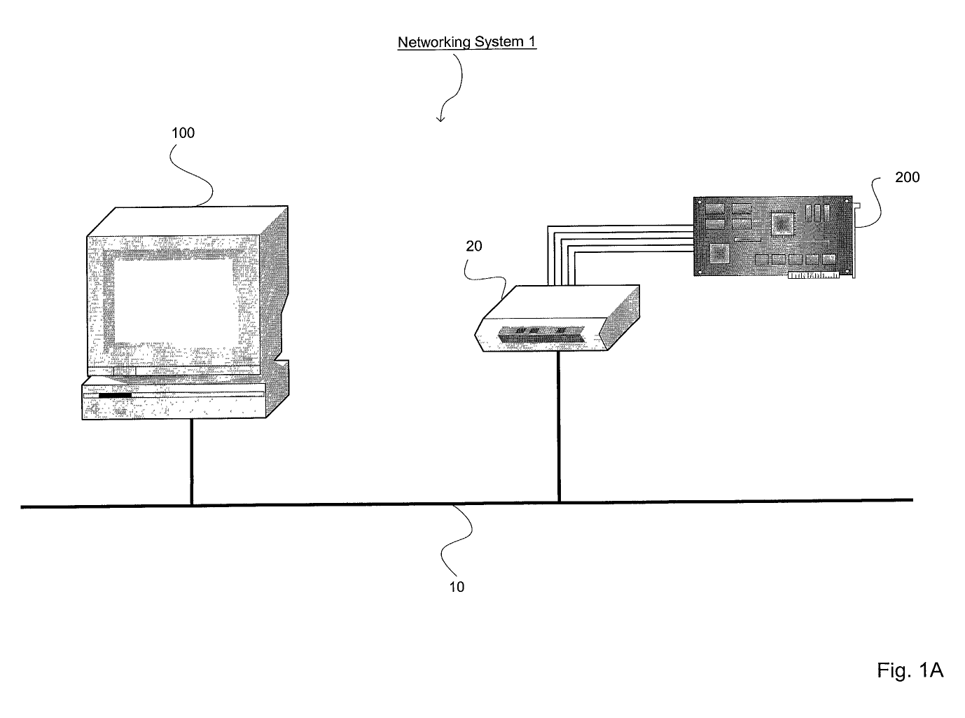

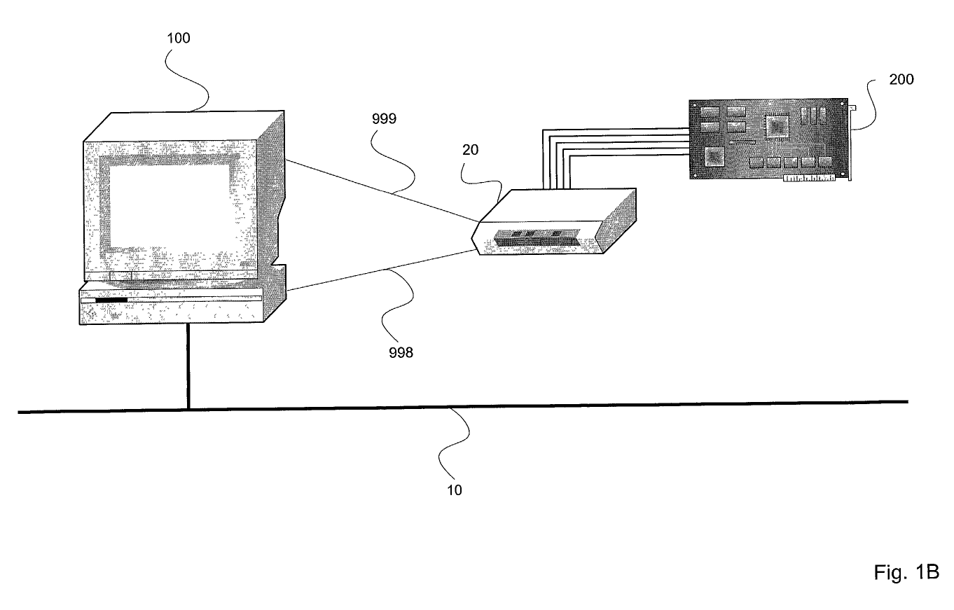

Graphical code generators assist developers in creating application software for embedded systems. In order for graphical code generators to be employed in the creation of application software for embedded systems, the system on which the developing is done and the embedded system for which the developing is done may be components in a networking system. FIG. 1A shows an exemplary networking system 1 with a host system 100 connected to a target system 200 via a network link 10 and a read-only memory (“ROM”) emulator 20 (such as one produced by Applied Microsystems Corp. of Redmond, Wash.). FIG. 1B shows an additional exemplary embodiment of a host system 100 connected to the target system 200 without a network connection containing a user physical link 998 and a debugger link 999. As will be familiar to those skilled in the art, a networking system may contain a plurality of host systems and/or a plurality of target systems.

Graphical code generators may utilize GUIs in order to communicate input and output data with the developer. GUI is a visual display presented to a developer via a display, e.g., CRT, LCD, etc. GUIs take advantage of the graphic capabilities of the displaying device to make the program easier to use by displaying graphical screen images as well as typed text. In certain instances, the graphical images on the screen replace some of the functions traditionally reserved for keyboard input. These functions may be accessed by the user in a variety of manners, such as, mouse click, touch screen, input, etc.

The host system 100 may be a system on which the developer creates application software such as, for example, a desktop computer. The host system 100 may contain the application tools utilized to develop certain application software. In addition, the host system 100 may provide a user interface front end that allows the developer to implement the application tools.

The target system 200 may be the system for which a particular software is being developed. An exemplary target system 200 may be a CPU board running a real-time operating system. The host system 100 and the target system 200 may be linked via the network link 10 which may be, for example, an Ethernet connection. The network link 10 may be utilized to create communication channels between the two systems. For example, the developer may use the tools on the host system 100 to develop application software for the target system 200. Once the software for the target system 200 has been developed on the host system 100, the developer may use the network link 10 in order to send the software code to the target system 200. When the target system 200 receives the code, the code may be integrated as a particular application software on the target system 200. Thus, the application software, which is developed on the host system 100, may be loaded and run on the target system 200.

One of the application tools on the host system 100 may be a graphical code generator. Graphical code generators integrate graphical software specifications and code generation technology to model the behavior of applications (e.g., embedded applications) and to improve the software development process. With graphical specifications, automatic code generation, graphical debugging, and round-trip engineering, graphical code generators offer embedded system developers significant benefits, such as simplifying software development, reducing design iterations, and facilitating maintenance and design reuse.

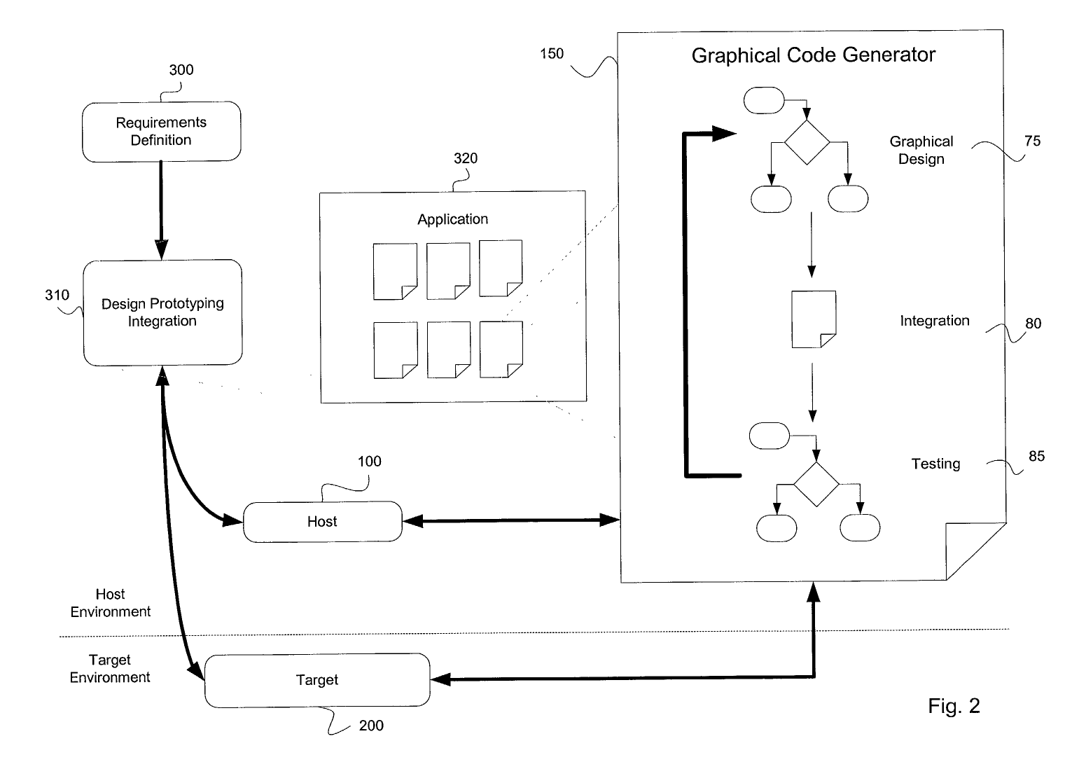

FIG. 2 shows an exemplary embodiment of a graphical code generator design process in a development environment. The host environment may contain requirements definition 300, design prototyping integration 310, applications 320, and the host system 100. The design prototyping integration 310 contains applications, one of which is a graphical code generator 150. Prior to this invention the code generator 150 is executed on the host 100 and is linked with the target environment. As will be familiar to those skilled in the art, a development environment may be constructed differently than that which is shown in FIG. 2.

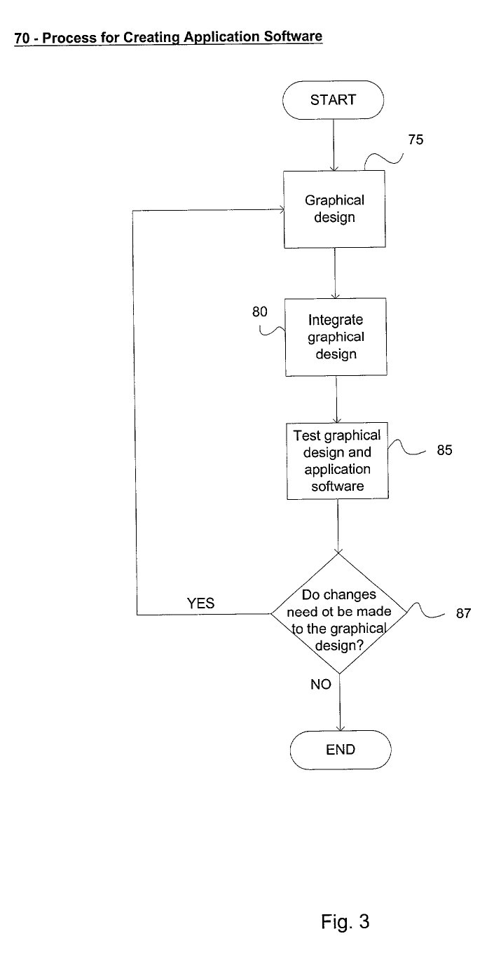

FIG. 3 shows an exemplary process 70 for creating an application software for embedded systems. The developer utilizes the graphical code generator, which is part of the development environment shown in FIG. 2, to create the application software. This process includes graphical design (step 75), integration (step 80) and testing (step 85). The developer may create a graphical design using the graphical code generator 150 (step 75). This graphical design may include the use of graphical constructs such as, for example, statecharts (discussed in further detail below). The resultant code is integrated into the target system 200 as application software (step 80). Next, at step 85, the application software is tested. The application software is tested to ensure that the software works as designed. This testing may include debugging of the code, logic testing, and sampling. In step 87, if changes need to be made to the graphical design (e.g., debugging, logic corrections, etc.), the developer will repeat the process beginning from step 75. If the graphical design is edited, the new code is integrated and the process repeats until the testing is completed.

Graphical code generators provide graphical programming capabilities based on graphical constructs. Software development is facilitated with diagrams that are easy to comprehend and maintain. Furthermore, programming is accelerated with rapid prototyping, automatic code generation, and faster design iterations. Software is converted to execution-ready software modules using graphical code generators by specifying software modules using advanced graphical constructs, implementing software modules via automatic code, integrating the code within a given application framework, and finally, graphically debugging the software modules that execute on a host or on a target.

The developer may specify behavioral modules using the graphical code generator's advanced graphical construct. Included in this process may, for example, be the creation of statecharts, flowcharts, race condition resolution, report generators, and unified modeling language (“UML”) support. Using the graphical code generator, the developer may implement the usage of several different types of diagrammatic configurations for representing complex software module behavioral models.

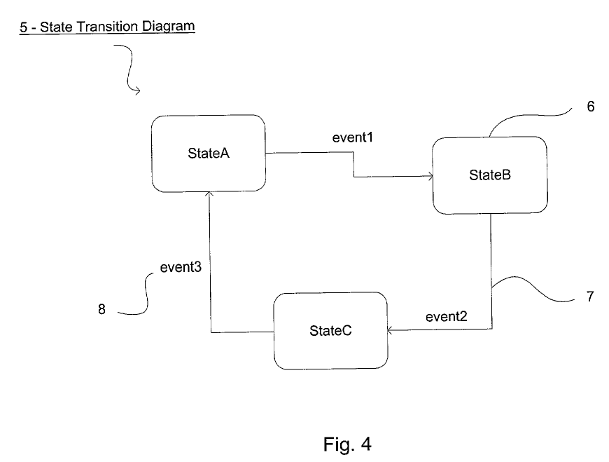

FIG. 4 shows an exemplary state transition diagram 5 with a plurality of states 6 (e.g., StateA, StateB, StateC) and transition elements 7 that are triggered when a plurality of events 8 occur (e.g., event1, event2, event3). The states 6 are the basic elements of the state transition diagram 5 that indicate situations during the object's life where it meets a condition, executes the event 8, and/or waits for the event 8. A system (e.g., the target system 200) may stay in the state 6 until an event occurs in the external environment which either (a) effects the state 6 or (b) effects another state in a concurrent process which generates an internal event which effects a state. For example, the system remains in StateA until event1 occurs, at which point the system transitions into StateB. Similarly, the system only transitions into StateC from StateB if event2 occurs.

Statecharts are extensions of the state transition diagram 5, augmented with, for example, hierarchy (for state nesting and top down design within the state diagrams), concurrence (for specification and design of multiple, partially independent sub-statecharts within other states), visual priorities, and visual synchronization. Statecharts may be used to address complex control systems, which traditionally have been too difficult to design using conventional state diagrams. Statechart diagrams emphasize the possible states of an object and the transitions between states. For example, a developer may use statecharts to model the lifetime of an instance of a system. During that period, the object of interest may be exposed to different types of events to which it responds with an action, and the result of which is a change in the object's state. Graphical code generators further enable developers to incorporate traditional flowchart constructs (e.g., cascaded decision polygons) on the same diagram as statechart constructs.

Each state 6 may have its own name and may be described through its characteristics. For example, the state 6 may be a default state, which is a means to specify the default activated state within a chart or thread, or the state 6 may be a terminal state, which suspends the chart's execution until the chart is re-activated.

Additionally, a statechart has transition elements 7 that are the conditional connections between two states. Valid changes of state in a system are called transitions. Transitions describe the means in which the system is to move from one state to another. Transitions may be condition-based and/or event-based. The action associated with each transition is executed when the transition occurs. Events define when transitions fire. For example, if an event occurs, the controller may move from one state to the next state connected to it by a transition. Conditions, which add checks to transitions, may, for example, be an observable condition in the environment or an internal system event (e.g., signal, interrupt, data packet arrival, etc.). As part of the change from one state to another state, the system may take one or more actions. These actions may be responses sent to the external environment, an internal event, or a calculation whose result is remembered by the system in order to respond to some future event.

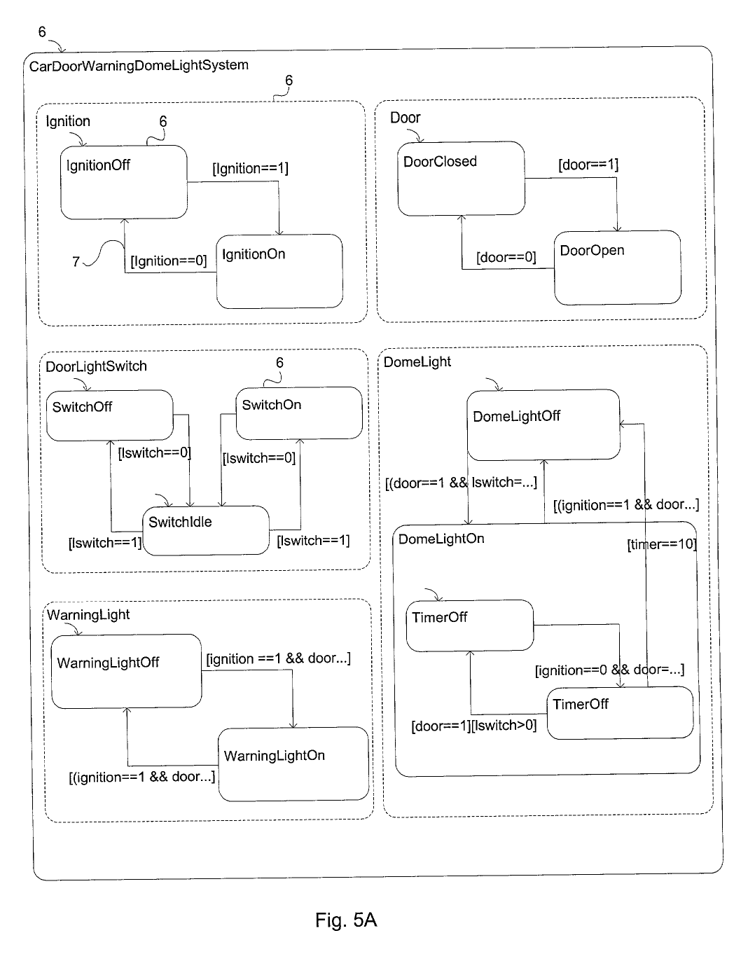

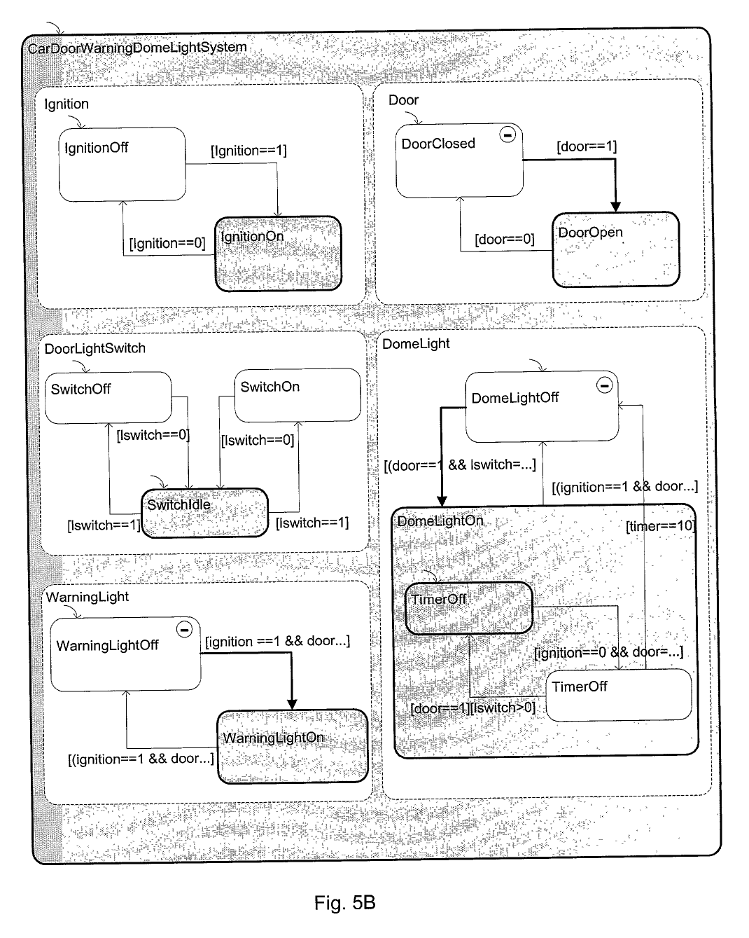

FIG. 5A shows an exemplary statechart diagram for controlling the functions of an interior lighting system in a motor vehicle. As in FIG. 4, the statechart consists of a plurality of states 6 (e.g., CarDoorWarningDomeLightSystem, Ignition, IgnitionOff, IgnitionOn, Door, DoorClosed, DoorOpen, etc.) and transition elements 7 (e.g., the lined arrows) triggered when a plurality of events 8 occur (e.g., [Ignition==1], [Ignition==0], [door==1], [door==0], etc). In FIG. 5A states are embedded within other states creating a hierarchy. For example, the IgnitionOff and IgnitionOn state are embedded within the Ignition state. This indicates that there are two possible substates within the Ignition state (i.e., while in state Ignition, the controller is either in state IgnitionOff or state IgnitionOn). Similarly, the CarDoorWarningDomeLightSystem state may be an embedded state within a larger state diagram which may, for example, consist of other functions for different parts of a motor vehicle. In addition, the statechart in FIG. 5A has threads represented by the dashed lines, which allow concurrent sets of states. For example, in the CarDoorWarningDomeLightSystem state, the controller may be in both state IgnitionOn, state DoorOpen and state SwitchIdle.

In FIG. 5A, the transition elements that connect the IgnitionOff and IgnitionOn states are triggered by the [Ignition==1] and [Ignition==0] boolean functions. If, for example, the ignition of a motor vehicle is turned on, the boolean function [Ignition==1] is satisfied, initiating the transition between the IgnitionOff state to the IgnitionOn state. Similarly, if the ignition of a motor vehicle is turned off, the [Ignition==0] boolean function is true, and the state diagram transitions between the IgnitionOn state to the IgnitionOff state. Each of the other states within FIG. 5A function in a similar manner. If, for instance, Ignition is in the IgnitionOn state and Door is in the DoorOpen state, the boolean expression in the WarningLight state is tested. If the expression is true, the state will transition from the WarningLightOff state to the WarningLightOn state.

Once the graphical programming is completed through the construction of statecharts and/or other graphical constructs, the graphical code generator implements and integrates the software module (step 80). The graphical code generator implements code generation algorithms to automatically generate execution-ready, optimized code in languages such as, for example, C, C++, JAVA, ADA and Handle-C. Code may be generated for an entire project, a single chart or for a subset of a chart using the ability to generate code for selected layers. The generated code may be ported from the development device (the host 100) to the system (the target 200) as application software or a software module.

Once a software module has been implemented and integrated, a developer may edit, test and/or debug the resultant code (step 85). A method in which the developer may debug the code is interactive state animation. In this process, the diagram may be automatically animated to reflect, for example, program execution, the active state, the previous state, and the transition from the previous state to the active state while the application software is being executed on the host system 100 or the target system 200. FIG. 5B shows an exemplary statechart with such state animations. The exemplary statechart depicted in FIG. 5A is shown again with animations which include highlighted states and highlighted transitions in FIG. 5B. If the developer invokes the debug function via an interactive state animation, the animations in FIG. 5B may be exemplary of the resultant animations during the debugging process. For example, states 6 and transition elements 7 may be highlighted in the state diagram to indicate the present state and present transition of the statechart. Those skilled in the art will recognize that highlighting is only an exemplary method of animating a state diagram. Other animations such as color coding or the use of symbols may be implemented.

In FIG. 5B states are highlighted to show that they are the present state of the application software that is being run (e.g., the CarDoorWarningDoneLightSystem, IgnitionOn, DoorOpen, SwitchIdle, WarningLightOn, DomeLightOn and TimerOff states). In addition, transition elements are highlighted to show the present transition of the application software (e.g., the transition between the DoorClosed and DoorOpen states, the transition between the WarningLightOff and the WarningLightOn states and the transition between the DomeLightOff and DomeLightOn states). The animation also includes a small circle around a minus sign. These symbols appear on the DoorClosed, WarningLightOff, and DomeLightOff states, and indicate the state which the system was in prior to the highlighted state (i.e., the previous state). For example, the transition element with the boolean expression [door==1] satisfied is highlighted along with the DoorOpen state. This denotes a change from the DoorClosed state (the previous state with the circle symbol) to the DoorOpen state which is highlighted. This debugging technique allows the developer to locate the error in the logic or code with visual ease. The embodiments according to the present invention provides an alternative method of animating the graphical diagrams implemented during the edit-test-debug cycle.

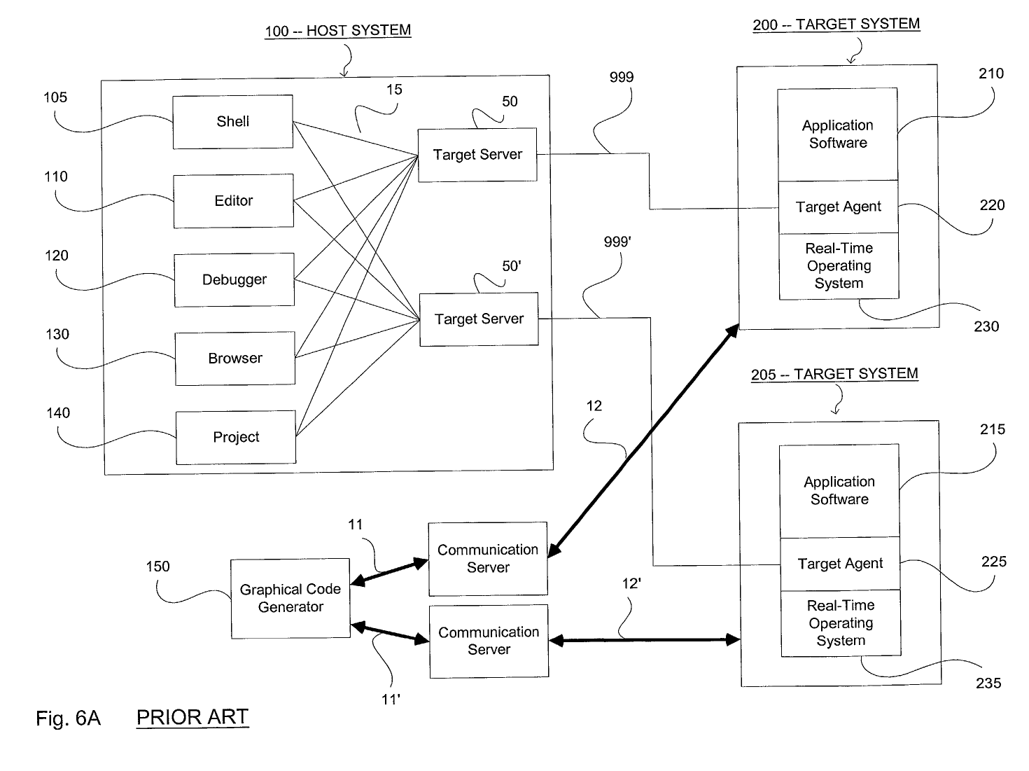

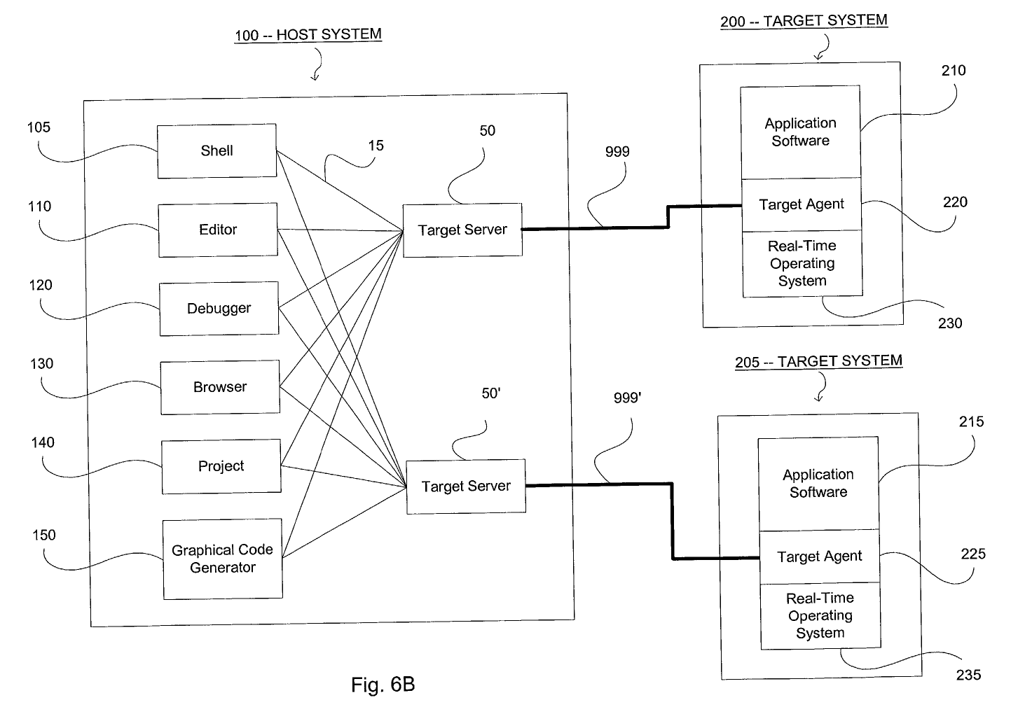

An integrated development environment (“IDE”) is a programming environment to develop an application. An exemplary IDE is the Tornado® integrated development environment sold by Wind River Systems, Inc. of Alameda, Calif. FIG. 6A shows an exemplary embodiment of a conventional development environment. The host system 100 may be running IDE software having application software tools 105-150 and target servers 50-50′. Those skilled in the art will recognize that the IDE software that is running on the host system 100 may include other applications such as, for example, a target agent and a target simulator. The host-side application software tools 105-150 may include, for example, a shell 105, an editor 110, a debugger 120, a browser 130, a project manager 140, and a graphical code generator 150. The shell 105 may be the outer most layer of a program, such as a user interface. The editor 110 may be a program that allows the developer to create and edit text or graphics. The debugger 120 may be a program that is used to find the errors in other programs. The browser 130 may monitor the state of the target system 200 by summarizing the active system and application tasks, memory consumption, and the current target memory map. The manager project 140 may be a manager of a pending design of application software. These host-side application software tools 105-150 may be linked to the target system 200 via network connections 15 which act as a centralized communication with the target system 200 so that multiple development tools may share access to the target even when communications channels are limited. The target system 200 may include a target agent 220, a real-time operating system 230, and application software 210 created by the graphical code generator 150.

The target server connections 15 provide requests that serve several functions. These functions may include, for example, managing sessions and logging level, supporting symbolic debugging in the system or task mode, attaching to a target server, accessing target memory, supporting disassembly requests, managing object modules, managing symbols, managing contexts, supporting virtual input and output, managing events, and supporting Gopher.

In the conventional system (shown in FIG. 6A), the graphical code generator 150 may establish a separate connection with each target server and with each target system in order to communicate the animation commands. For example, when the target has no network link, the graphical code generator 150 may establish a Remote Procedure Call (“RPC”) mechanism (i.e., link 11) with a communication server 997 on the host side when it initializes. The communication server creates a serial connection 12 to the target system 200. The communication server 997 must contain serial communication setup and connection code that is specific to the target being used, such as one supplied by Wind River Systems, Inc. of Alameda, Calif. The application software 215 on the target side must contain serial setup and communication code, integrated with the code generated by the graphical code generator 150 in the compilation process, such as one supplied by Wind River Systems, Inc. of Alameda, Calif. Furthermore, the code is specific for each target system. Thus, a different code needs to be written for each target system the host is linked to. For each target system the host system 100 connects to, a separate set of connections must be created. For instance, in FIG. 6A, if an additional target system 205 is linked to the host system 100, the graphical code generator 150 must create links 11′-12′ to connect to target system 205.

The embodiment according to the present invention allows the developer to eliminate these additional links 11, 12, 11′ and 12′ by communicating the animation commands via the target servers 50 and 50′. FIG. 6B shows an exemplary development environment according to the present invention. The graphical code generator 150 is connected to the target server 50-50′ via connections 15. Generally, a single target server is dedicated to one target system. The target servers 50-50′ are then connected to the target systems 200-205, respectively, via the debugger links 999 and 999′. The necessary data, including animation commands for debugging, are sent via the debugger links 999 and 999′ already established by the target servers 50-50′, rather than via the separate links 11-12.

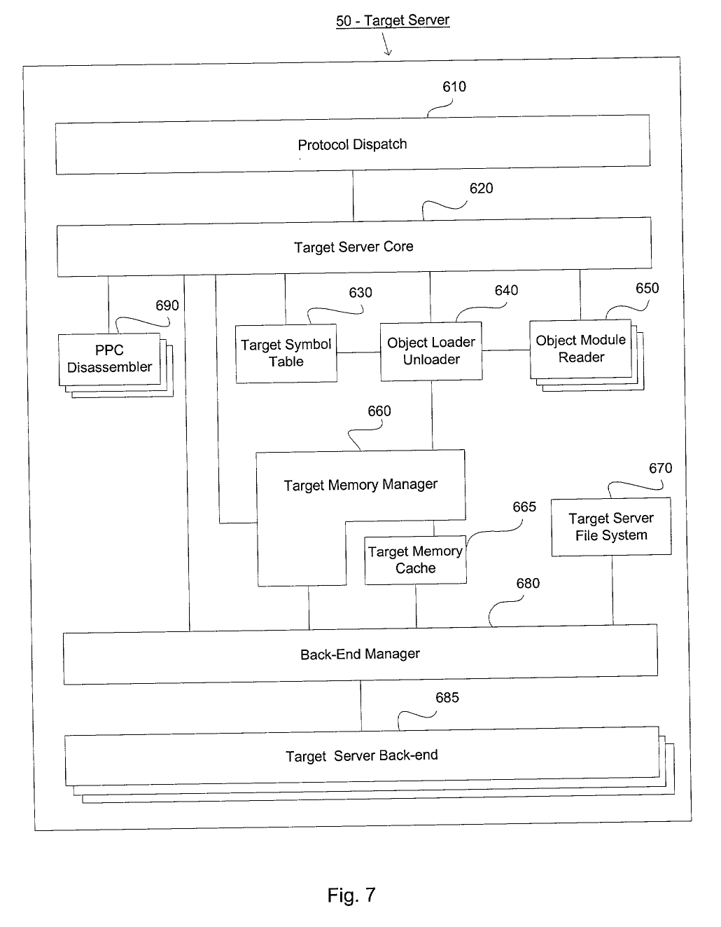

FIG. 7 shows an exemplary embodiment of the internal architecture of the target server 50. The target server 50 may include a protocol dispatch 610 which implements a communication protocol for communication between application tools and the target server 50 (e.g., Wind Tool exchange (WTX) by Wind River Systems, Inc. of Alameda Calif.), a target server core 620, a target symbol table 630, an object loader/unloader 640, an object module reader 650 (e.g., an Extensible Linking Format (“ELP”) object module reader), a target memory manager 660, a target memory cache 665, a target server file system 670, a back-end manager 680, an agent back-end 685, and a Target CPU disassembler 690.

The protocol dispatch 610 allows the target server 50 to link and communicate to the application tools 105-150 on the host system 100. The target server core 620 contains the interpreter for the WTX protocol. It is here that the target server 50 determines what services to perform locally on the host system 100, and what services to pass along to the agent back-end 685 to transmit to the target system 200. WTX services that can be carried out entirely in the target server 50 are implemented in the target server core 620; general-purpose callbacks used by other parts of the target server 50 also reside here. As the object modules may come in many formats, the target server 50 isolates the object module format reader 650 from the target server core 620. The object loader/unloader 640 uses the target symbol table 630 to resolve undefined references in modules being loaded, dynamically linking newly loaded modules to previously loaded modules. In addition, the target server 50 provides the ability to unload modules from the target system 200. When a module is removed, all the associated symbols are removed from the target symbol table 630 and memory is reclaimed. The object module reader 650 simplifies the process of adding new object module formats without requiring a new release of the target server 50. The target memory manager 660 manages a pool of target memory for all allocation requests originating on the host system 100. This eliminates the need to call upon the target server 50 to manage a pool of memory on the host-side application software tools' behalf. The target memory cache 665 caches the program text sections of all the target-resident modules. The back-end manager 680 maps a transport-independent layer of subroutine calls, used by the rest of the target server 50, into the appropriate transport-dependent calls for a particular back-end. The target server back-end 685 allows the target server 50 to link to the target agent 220 on the target system 200 using a communication protocol (e.g., TDB, WDB). The target CPU disassembler 690 may be called on to disassemble a region of target memory.

The graphical code generator 150 may communicate with external programs on the target server 50 using a network protocol such as, for example, WTX. The target server 50 allows development tools, such as the host-side application software tools 105-150, to be independent of the target system 200. Thus, there may be a single target server for each target system. Instead, the host-side application software tools 105-150 may access the target system 200 through this target server 50. The target server 50 satisfies tool requests by breaking each request into the necessary transaction with the target agent 220. The target system 200 may include features which improve the performance of the cross-development structure, such as, for example, a target memory cache, host-based target memory management, and a streamlined host-target protocol (e.g., WDB) to reduce communication traffic.

The target server 50 runs on the host system 100 and manages communications between the host-side application software tools 105-150 and the target system 200. However, as is known in the art, the target server 50 need not be on the same host system 100 as the host-side application software tools 105-150, as long as the application software tools 105-150 have the debugger link 999 to the host system 100.

The target agent 220 connects all the host-side application software tools 105-150 to the real-time operating system 230, giving the target system 200 independence from the host system 100. Both the target agent 220 and the target agent's driver interface are independent of the real-time operating system 230. As a result, the target agent 220 may execute before the operating system kernel is running, thus simplifying the bring-up of the networking system 1 on custom hardware. In order to communicate with the target agent 220, the target server 50 may use a communication back end configured for the same communication protocol and transport layer as the target agent 220. Each target system 200 connects to the target server 50 associated with the target system 200 executing the application software 210 via a network protocol such as, for example, Wind Debug (“WDB”) by Wind River Systems, Inc. of Alameda, Calif., over the debugger link 999. Thus, the target server 50 acts as a broker for the communication path to the target system 200. In the exemplary development environment depicted in FIG. 6B, the target server 50 is configured for the target system 200, and started, before the host-side application software tools 105-150 interact with the target system 200.

In order for the target system 200 to be able to communicate with the graphical code generator 150, the target system 200 must be able to support the protocol set in the links 11-12 (e.g., RPC). According to the preferred embodiment of the present invention, however, the second link is removed completely, and the debugging information is passed via the already existent target server connections 15 and debugger link 999, thus, reducing the connection requirements.

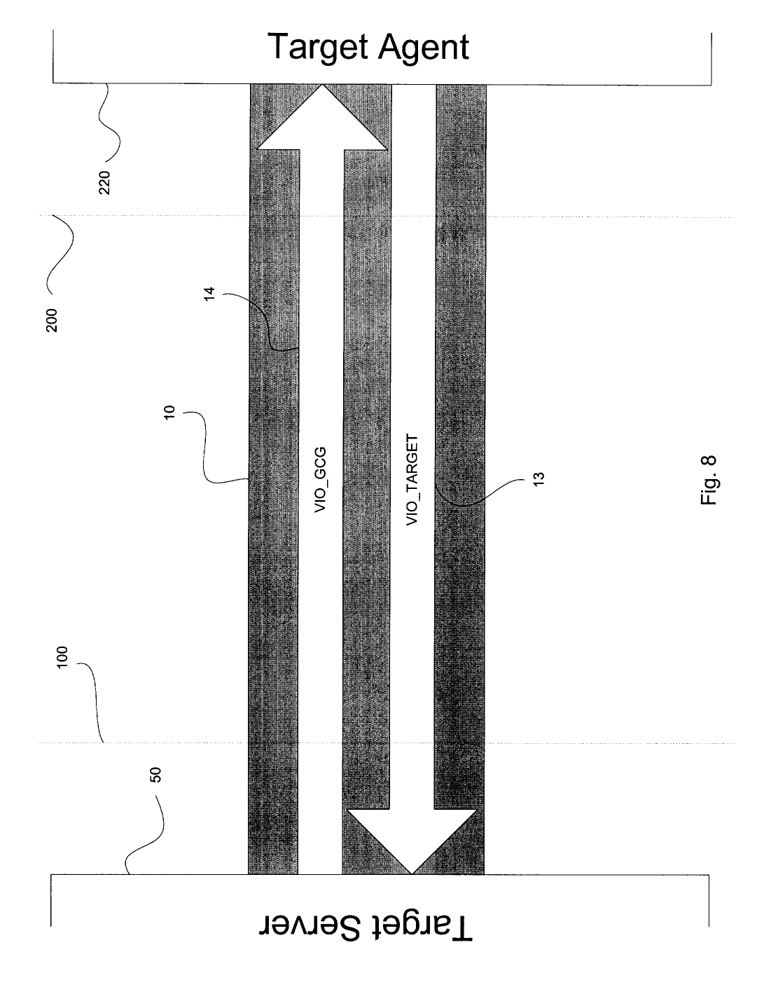

FIG. 8 shows an exemplary embodiment of the debugger link 999 between the target server 50 and the target agent 220. Within the debugger link 999, there are two virtual channels VIO₁₃ TARGET 13 and VIO_GCG 14. These virtual channels 13-14 replace the communication links between the target system 200 and the graphical code generator 150 of the conventional system (e.g., links 11-12 and 11′-12′). Those skilled in the art will recognize that the debugger link 999 depicted in FIG. 8 is only exemplary. As such, the debugger link 999 may contain more virtual channels than the two that are shown.

As is well known, the debugger link 999 may comprise a multi-layer communications medium. The preferred embodiment described here uses an Ethernet connection, although other mediums and protocol are possible substitutes (e.g., a serial link).

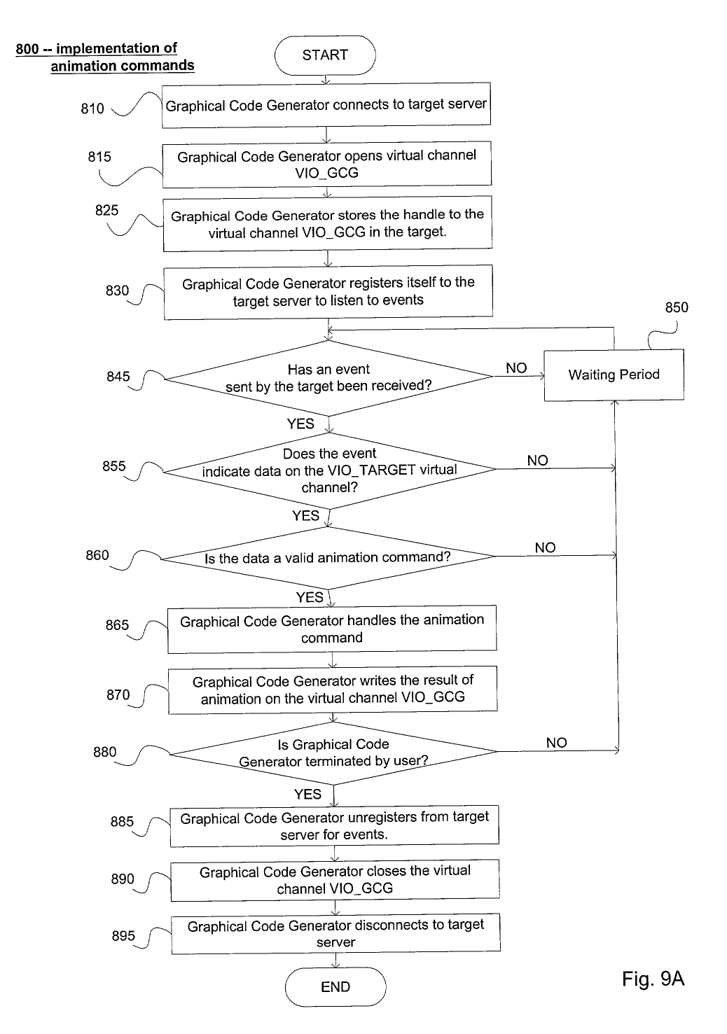

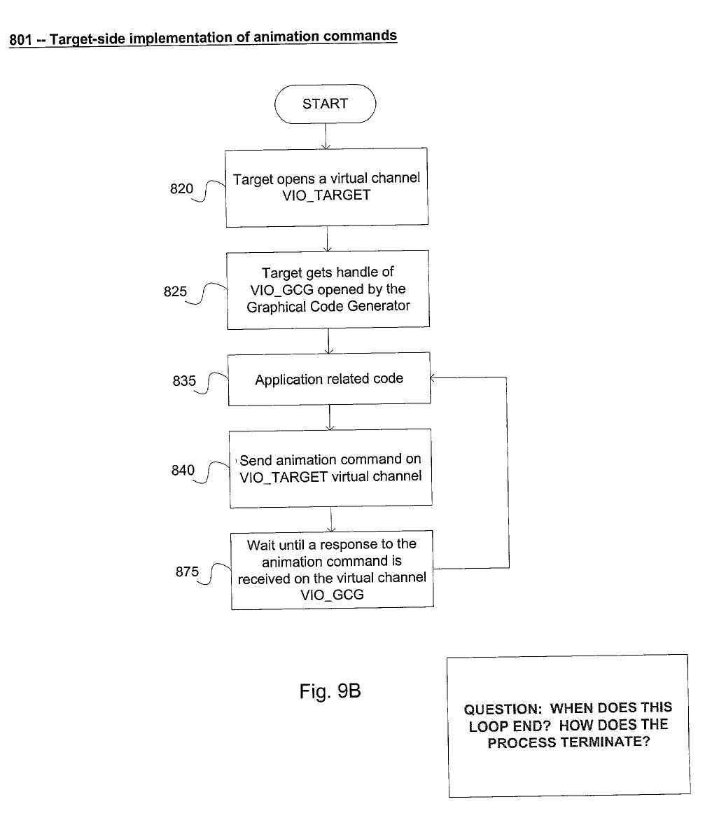

As described above, the graphical code generator 150 communicates with the integrated development environment using a network protocol. FIG. 9A shows an exemplary method 800 for communication between the graphical code generator 150 and the target server 50 according to the present invention. FIG. 9B shows an exemplary method 801 for the application software 210 to send animation data (which may include animation commands) to the target server 50 according to the present invention. In step 810, the graphical code generator 150, using network connections 15, connects to the target server 50 associated with the target system 200 executing the application software 210 via a protocol for each target system 200.

On the host-side, once connected to the target server 50, the graphical code generator 150 opens a virtual channel, for example VIO_GCG 14, to the target system 200 (step 815). A handle to the opened virtual channel is written to the target symbol table 630 with a well-known symbol name (step 825). Next, the graphical code generator 150 registers itself with the target server 50 to be notified of virtual channel related events (step 830). The virtual channel VIO_GCG 14 is used by the graphical code generator 150 to send data to the target system 200. The developer may select the virtual channel VIO_GCG 14 by specifying it as a command line argument to the graphical code generator 150. On the target side, the application software 210 opens another virtual channel, for example, VIO_TARGET 13, when it is executed on the target system 200 (step 820 of FIG. 9B). At this point, the graphical code generator 150 is initialized to communicate with the application software 210.

After the graphical code generator 150 is initialized, it waits (step 850) for transmission of the animation data from the application software 210 executing on the target system 200 (step 845). The application software 210 sends the animation data on the virtual channel VIO_TARGET 13 when the animation event occurs (step 840 FIG. 9B). The target server 50 checks whether the data indicates data on the virtual channel VIO_TARGET 13 that the application software tools 105-150 are interested in (step 855). The target server 50 creates an event and sends it to the graphical code generator 150. The graphical code generator 150 examines the event in order to determine the type of event received and the data associated with the event, and processes it. If an animation command is not received, the graphical code generator 150 waits for another event to be received. If the event does indicate data on the virtual channel, the format is scanned in order to verify that the data is valid animation data (e.g., an animation command) (step 855). Again, if it is not valid data, the event will be rejected, and the graphical code generator 150 waits to receive another event from the target server 50 (step 850). Once the event is verified, the graphical code generator 150 handles the animation data (step 865) and writes the result of the animation on the virtual channel VIO_GCG 14 (step 870). At this point, the application software 210 receives the results of the animation via the virtual channel VIO_GCG 14 (step 875) and continues with its execution.

There are two virtual channels 13-14 opened for the two sides of the communication. The graphical code generator 150 listens for data including animation data to be sent via the virtual channel VIO_TARGET 13. On each animation call in the application software 210, data, including animation data, is transmitted to the virtual channel VIO_TARGET 13. Then, the graphical code generator 150 is informed by the target server 50 of an event. Once such an event is received, the graphical code generator 150 parses the data associated with the event and updates its graphical user interface (“GUI”) accordingly. The response to the animation data is sent back to the target system 200 via the virtual channel VIO_TARGET 13 (step 830). The point to note is that after sending the animation data via the virtual channel VIO_TARGET 13, the target system 200 waits for the graphical code generator 150 to respond on the virtual channel VIO_GCG 14 (step 875 FIG. 9B).

Once the animation command is executed, the developer may terminate the graphical code generator 150 (step 880). If the developer chooses to continue the debugging process, the graphical code generator 150 returns to step 850. Otherwise, the graphical code generator 150 unregisters from the target server for events (step 885), closes the virtual channel VIO_GCG 14 (step 890) and disconnects from the target server 50 (step 895).

The implementation according to the present invention may be divided into two modules: a host-side implementation module (represented by FIG. 9A) and a target-side implementation module (represented by FIG. 9B). The host-side implementation may allow the graphical code generator 150 to connect to the target server 50 without establishing direct connections to target systems. Once connected to the target server 50, the graphical code generator 150, with some initialization, is able to listen to animation data from the target system 200. Initialization may include creating a connection with the integrated development environment, attaching to a particular target server (i.e., target server 50), registering with that target server for all types of events, creating and opening a virtual channel, creating a symbol in the target symbol table 630 by name and saving the handle of the virtual channel just opened. Once the graphical code generator 150 is initialized, every animation command is handled and a return value is sent back to the target system 200.

During the target-side initialization, the virtual channel VIO_TARGET 13 is opened and the value of the symbol is created by the graphical code generator 150. The value of this symbol is the handle of the virtual channel VIO_GCG 14 opened by the graphical code generator 150. Once the initialization is completed, the application software 210 may send animation requests to the graphical code generator 150. In order to do this, the application software 210 may write animation data to the virtual channel VIO_TARGET 13. This data results in the target server 50 generating a single event for the graphical code generator 150. Once the animation data is processed, the return value is sent on the virtual channel VIO_GCG 14. The data received on the channel may be terminated by, for example, a‘\0’ byte. The data read may be in string form, in which case, it may be converted to an integer. This is the return value of the animation data sent by the application software 210. The application software 210 will continue to send animation data in this manner as long as required, at which time, the virtual channel VIO_TARGET 13 is closed.

When application software 210 writes animation data on to channel VIO_TARGET 13, the target server 50 listening to the virtual channel VIO_TARGET 13 will know that there is data from the target system 200. The target server 50 checks to see if there are any application software tools 105-150 interested in this data (i.e., the graphical code generator 150). The target server 50 creates an event and sends it to the graphical code generator 150. Each event also includes information regarding a particular virtual channel which is utilized to send the data. The animation data sent to the graphical code generator 150 may include commands. These animation data may, for example, be of three types—initialization, additive, or regular commands. The initialization commands perform a clean up of the vector of previous animation states and/or transitions and the vector of current animation states and/or transitions. The additive commands do not perform a clean up. The regular commands perform a clean up of the vector of previous animation states and/or transitions. Each of the commands contain a chart identifier and an instance number of the chart.

In addition, these commands may contain a state identifier, a transition identifier, and a time variable which indicates the time when the code for the chart is generated. The state and transition identifiers are used to mark the current and previous state and the affected transitions in the code editor GUI. The time variable information may be used to determine whether the chart has been modified after the code is generated, in which case there may be inconsistencies in the application software 210 and the chart. The animation data may be in Backus Naur Form (“BNF”) and may follow the following format:

<Animation Command>:=A<Animation Command ID><Animation Command Data>
<Animation Command Data>:=<ChartID>˜<Chart Instance>˜<AnimationObjects>+
<AnimationObjects>:=<Animation Object Data>˜
<Animation Object Data>:=<State> | <Transition> | <Time>
<State>:=<State Command type> <State index> # <State ID>
<Transition>:=<Transition Command type> <Transition ID>
<Time>:=M<Number> & <Number> & <Number> & <Number>
<Animation Command ID>:= +|−|ˆ
<State Command type>:=P|I
<Transition Command type>:=R|T
<Chart ID>:= Any non-negative integer
<Chart instance>:=Any non-negative integer
<Number>:=Any non-negative integer
<State index>:=Any non-negative integer
<Transition ID>:=Any non-negative integer
<Message>:=Any string of characters
<State ID>:=Any non-negative integer

Those of skill in the art will recognize that the BNF syntax “:=” means equivalent, “|” represents or, “X+” indicates one or more X's, the bold text indicates a string literal, and the italicized text indicates the means in which to construct the string or numeric literal.

An advantage achieved by the embodiment described above is the elimination of additional communication links previously needed in order to transmit animation data between the target and the graphical code generator. The additional communication links reduce the required functionality of the real-time operating system, and, hence, reduces the size of the real-time operating system and operational latency (delay).

Another advantage achieved by the embodiment described above is the efficient use of the existing debugger link. Irrespective of the capabilities of the target, the target server always works in conjunction with the target, thus, a graphical code generator may always communicate with application software via a target server. Additional communications software and hardware need not be developed, thereby reducing implementation time and cost.

Furthermore, the embodiment described above eliminates the low-level details of communication to the network protocol between the graphical code generator and the target server and moves semantics of animation into the application layer of the networking stack paradigm, thus, increasing the level of abstraction and aiding in portability to alternative targets and communications mediums.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A method, comprising the steps of:
establishing a tool communication link between a graphical code generator and a target server, the target server being connected to a target system via a target communication link;
establishing a virtual communication channel within the target communication link between the target server and the target system;
receiving animation data from the target system, via the target server, using the virtual communication channel; and
providing the animation data to the graphical code generator.

2. The method according to claim 1, wherein in the receiving step, the animation data is received without establishing a direct communication link between the code generator and the target system.

3. The method according to claim 1, wherein the animation data includes animation commands utilized by the graphical code generator.

4. The method according to claim 1, further comprising the step:
upon receiving the animation data, updating a display of the target system as a function of the animation data.

5. The method according to claim 1, further comprising the steps:
upon receiving the animation data, generating predetermined data to acknowledge a receipt the animation data from the target system by the graphical code generator; and
providing the predetermined data to the target system using the virtual communication link.

6. The method according to claim 1, further comprising the step of:
closing the virtual communication channel after the animation data between the graphical code generator and the target system have been exchanged.

7. The method according to claim 1, wherein the virtual communication channel includes first and second virtual subchannels.

8. The method according to claim 7, further comprising the step of:
generating software code by the graphical code generator.

9. The method according to claim 7, further comprising the step of:
receiving the animation data, via the second virtual subchannel, by the graphical code generator from the target system.

10. The method according to claim 7, further comprising the step of:
sending the software code, via the first virtual subchannel, by the graphical code generator to the target system.

11. The method according to claim 9, further comprising the step of:
collecting the animation data as a function of the software code, the animation data being provided via a graphical user interface.

12. The method according to claim 9, further comprising the steps of:
generating further software code by the graphical code generator as a function of the software code and the animation data; and
providing the further software code, via the first virtual subchannel, by the graphical code generator to the target system.

13. The method according to claim 1, further comprising the step of:
monitoring the target communication link to detect the animation data.

14. The method according to claim 1, wherein the animation data is stored utilizing a predetermined storage format.

15. A system, comprising:
a target server coupled to a target system via a target communication link; and
a graphical code generator coupled to the target server via a tool communication link, the graphical code generator configured to establish a virtual communication channel between the target server and the target system over the target communication link and to receive animation data from the target system via the virtual communication channel and the target server.

16. The system according to claim 15, wherein the animation data is received without establishing a direct communication link between the code generator and the target system.

17. The system according to claim 15, wherein the animation data includes animation commands utilized by the graphical code generator.

18. The system according to claim 15, wherein, upon receiving the animation data, a display of the graphical code generator is updated as a function of the animation data.

19. The system according to claim 15, wherein, upon receiving the animation data, predetermined data is generated to acknowledge a receipt the animation data from the target system by the graphical code generator, the predetermined data is provided to the target system using the virtual communication link.

20. The system according to claim 15, wherein the virtual communication channel is closed after the animation data between the graphical code generator and the target system have been exchanged.

21. The system according to claim 15, wherein the virtual communication channel includes first and second virtual subchannels.

22. The system according to claim 21, wherein the graphical code generator generates software code as a function of the animation data.

23. The system according to claim 21, wherein the animation data is received, via the second virtual subchannel, by the graphical code generator from the target system.

24. The system according to claim 22, wherein the software code is send, via the first virtual subchannel, by the graphical code generator to the target system.

25. The system according to claim 23, wherein the animation data is collected as a function of the software code, the animation data being provided via a graphical user interface.

26. The system according to claim 23, wherein further software code is generated by the graphical code generator as a function of the software code and the animation data, and wherein the further software code is provided, via the first virtual subchannels, by the graphical code generator to the target system.

27. The system according to claim 15, wherein the target communication link is monitored to detect the animation data.

28. The system according to claim 15, wherein the animation data is stored utilizing a predetermined storage format.

29. A method, comprising the steps of:
establishing a tool communication link between a graphical code generator and a target server, the target server being connected to a target system via a target communication link;
establishing a virtual communication channel within the target communication link between the target server and the target system;
communicating animation data between the graphical code generator and the target system, via the target server, using the virtual communication channel; and
when the animation data is received by the target server, providing the animation data to the graphical code generator.

30. A system, comprising:
a target system;
a target server coupled to the target system via a target communication link; and
a graphical code generator coupled to the target server via a tool communication link, the graphical code generator configured to establish a virtual communication channel between the target server and the target system over the target communication link,
wherein communications of animation data between the graphical code generator and the target server utilizes the virtual communication channel.
